(19) United States
(12) Patent Application Publication
(10) Pub. No.: US 2012/0063118 A1
(43) Pub. Date: Mar. 15, 2012

(54) BARREL GRINDING OF LUMIRAMIC PLATELETS

(75) Inventors: Johannes Franciscus Maria Cillessen, Eindhoven (NL); Petrus Cornelis Paulus Bouten, Eindhoven (NL)

(73) Assignee: KONINKLIJKE PHILIPS ELECTRONICS N.V., EINDHOVEN (NL)

(21) Appl. No.: 13/321,872

(22) PCT Filed: May 18, 2010
(86) PCT No.: PCT/IB2010/052205

§ 371 Date: Nov. 22, 2011

(30) Foreign Application Priority Data
May 28, 2009 (EP) 09161348.9

(51) Int. Cl. F21V 9/16; B24C 1/00; B32B 18/00

(52) U.S. Cl. 362/84; 428/192; 451/40

(57) ABSTRACT

The invention relates to a method for post-processing luminescent ceramic bodies (3). The method includes the steps of adding to a container a predefined amount of luminescent ceramic bodies (3) and grinding the luminescent ceramic bodies (3) in the container until edges (5) of the luminescent ceramic bodies (3) are chamfered. Chamfering the edges (5) increases the strength of the bodies (3) and decreases their susceptibility for damage, thereby reducing the chance of chipping.

### FIELD OF THE INVENTION

The invention relates to the field of designing and fabricating semiconductor light-emitting devices and, more specifically, to a method for post-processing luminescent ceramic bodies for use in wavelength converting devices.

### BACKGROUND OF THE INVENTION

White light may be obtained by partial conversion of a blue light with a wavelength converting material such as a phosphor. The blue light, emitted e.g. by a light emitting diode (LED), excites the phosphor, causing the phosphor to emit light of a different color, e.g. a yellow light. The blue light emitted by the LED is mixed with the yellow light emitted by the phosphor, and the viewer perceives the resulting mixture of the blue and yellow light as a white light.

In a typical production process, the phosphor is produced either as a powder or as a ceramic material in the form of a slab. In the case of a ceramic material, the slabs are machined into individual luminescent ceramic bodies, often in the form of platelets (sometimes referred to as “Lumiramic™ platelets”) by standard separation techniques, like grinding or dicing.

Lumiramic™ platelets produced in this manner have a well-defined shape. The separation process induces (mechanical) damage near the edges, such as chipping and cracks. This damage might affect the strength of the product. Apart of this, the damage and the edge geometry of the platelet affect the optical performance of the product (e.g. light leakage).

Therefore, there exists a need in the art for providing an improved method for processing Lumiramic™ platelets that overcomes at least some of the problems described above.

### SUMMARY OF THE INVENTION

A method for post-processing luminescent ceramic bodies is disclosed. The method includes the steps of adding to a container (such as e.g. a barrel) a predefined amount of luminescent ceramic bodies and grinding the luminescent ceramic bodies in the container until edges of the luminescent ceramic bodies are chamfered. The luminescent ceramic bodies are arranged to convert a primary radiation emitted by a light source into a secondary radiation.

As used herein, the term “chamfered edges” refers to edges comprising surfaces that do not form sharp angles with adjacent surfaces. In other words, the term “chamfered edges” refer to edges that do not have corners of 90 degrees or less. Chamfered edges may include e.g. faceted edges or rounded off edges.

Further, as used herein, the term “grinding” refers to grinding the luminescent ceramic bodies to produce chamfered edges, which is a part of post-processing of the ceramic bodies (as opposed to e.g. grinding the slabs of the material into individual luminescent ceramic bodies, as described in the background section, which is a part of typical processing of the ceramic bodies).

A luminescent ceramic body and a wavelength converting device including such a body are also disclosed. The wavelength converting device includes a light source configured to emit a primary radiation. The luminescent ceramic body is disposed in a path of the primary radiation emitted by the light source and configured to convert the primary radiation into a secondary radiation, where the edges of the luminescent ceramic body are chamfered.

The gist of the invention resides in chamfering the edges of the luminescent ceramic bodies by barrel-grinding the ceramic bodies. Chamfering the edges increases the strength of the bodies and decreases their susceptibility for damage, reducing the chances of chipping. Furthermore, chamfering the edges may reduce light leakage, thereby improving the efficiency of the wavelength converting device. Chamfering the edges using barrel-grinding enables post-processing of large quantities of Lumiramic™ platelets, which is particularly useful in mass-production.

Embodiment of claim 2 allows grinding the luminescent ceramic bodies mixed with a grinding substance and embodiment of claim 4 allows separating the luminescent ceramic bodies from the grinding substance. Claim 3 specifies advantageous types of grinding substances. Claims 5 and 6 specify advantageous manners of carrying out the separation.

Claims 7 and 8 advantageously allow grinding the luminescent ceramic bodies on a roller bench.

Embodiment of claim 9 specifies a grinding time.

Embodiments of claims 10-12 and 14 specify advantageous types of chamfered edges.

Hereinafter, embodiments of the invention will be described in further detail. It should be appreciated, however, that these embodiments may not be construed as limiting the scope of protection for the present invention.

### BRIEF DESCRIPTION OF THE DRAWINGS

In the drawings:

FIG. 1 shows a schematic illustration of a wavelength converting device according to one embodiment of the invention;

FIG. 2 shows a flow diagram of method steps for post-processing luminescent ceramic bodies according to one embodiment of the invention;

FIG. 3A shows a schematic illustration of a luminescent ceramic body before grinding according to one embodiment of the invention;

FIG. 3B shows a schematic illustration of a luminescent ceramic body after grinding according to one embodiment of the invention; and

FIG. 3C shows a schematic illustration of a luminescent ceramic body after grinding according to another embodiment of the invention.

### DETAILED DESCRIPTION OF THE DRAWINGS

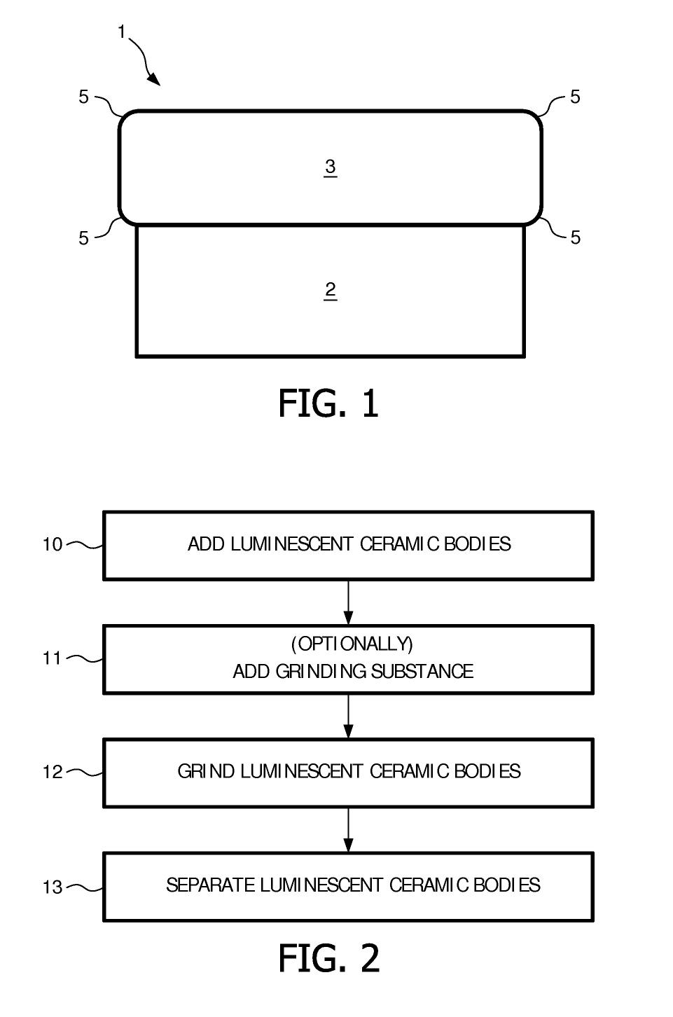

FIG. 1 shows a schematic illustration of a wavelength converting device 1 according to one embodiment of the invention. As shown, the wavelength converting device 1 includes a light source 2 and a luminescent ceramic body 3.

The light source 2 is configured to emit a primary radiation of a certain wavelength. In one embodiment, the light source 2 comprises an LED emitting blue light in the wavelength range of 390 nm to 480 nm, preferably 420-460 nm. Such an LED may include an active layer comprising a semiconductor material selected e.g. from the group of gallium indium nitride and/or gallium nitride. These semiconductor materials emit relatively short-wave primary radiation when driven electrically. According to the present invention, several LEDs may also be used in the device 1 to provide primary radiation.

The ceramic body 3 is generally a self-supporting body, preferably in the form of a platelet (i.e., in the shape of a parallelepiped with 90 degrees angles), disposed in a path of the primary radiation emitted by the light source 2 (i.e., the ceramic body 3 is disposed on top of or at a predefined distance from the top of the light source 2). Other geometrical shapes of the ceramic bodies 3 are also included within the scope of the present invention.

The ceramic body 3 is composed of a ceramic phosphor or a blend of ceramic phosphors and configured to convert at least a portion of the primary radiation emitted by the light source 2 into a secondary radiation. As used herein, “conversion” refers to a conversion of a radiation having a first wavelength to a radiation having a second wavelength which is different (typically longer) than the first wavelength.

By “composed of a ceramic phosphor” is meant that the ceramic body 3 essentially consists of a ceramic phosphor. However, the ceramic body 3 “composed of a ceramic phosphor” may nevertheless be not 100% ceramic phosphor due to e.g. impurities. Alternatively, the ceramic body 3 may be composed of a ceramic phosphor mixed and co-sintered with another ceramic material.

As used herein, the term “phosphor” refers to a material that exhibits the phenomenon of luminescence. Examples of appropriate materials used for the ceramic bodies 3 are base materials such as aluminates, garnets, or silicates, which are partly doped with a rare earth metal. For a blue emitting light source 2, the luminescent material preferably comprises a yellow emitting phosphor, such as a (poly)crystalline cerium doped yttrium aluminum garnet (YAG:Ce³⁺ or Y₃Al₅O₁₂:Ce³⁺) or manganese doped zinc sulphide (ZnS:Mn²⁺). Alternatively, YAG:Ce³⁺ may be co-sintered with Al₂O₃. For a high light power, it is particularly advantageous if the ceramic body 3 is translucent and/or transparent to the primary radiation and/or secondary radiation.

As also shown in FIG. 1, edges 5 of the ceramic body 3 are chamfered. Advantageously, chamfering the edges reduces the chance of chipping, decreases light leakage, and improves efficiency of the wavelength converting device 1.

The wavelength converting device 1 may be incorporated e.g. in a lighting appliance.

FIG. 2 shows a flow diagram of method steps for post-processing luminescent ceramic bodies having chamfered edges according to one embodiment of the invention. The method begins in step 10, where ceramic bodies 3 are added to a grinding container, such as e.g. a barrel. Optionally, in step 11, grinding substance is added to the barrel. The grinding substance may comprise e.g. a powder of abrasive particles, a suspension of abrasive particles in a liquid, or abrasive particles contained in a paste, possibly with additional ceramic balls (e.g., alumina). In one embodiment, the grinding substance comprises abrasive powder, e.g. SiC, B₄C, CeO₂, Cr₂O₃, Al₂O₃, SnO₂, ZrO₂, diamond, c-BN, glass, or colloidal silica (SiO₂) suspended in a liquid, e.g. water. In step 12 the ceramic bodies 3 are ground (rolled) in the container until the edges 5 of the ceramic bodies 3 are chamfered. If the grinding substance was added in the optional step 11, then, in step 12, the ceramic bodies 3 are ground (rolled) in the container together with the grinding substance. The method ends in step 13, where the ceramic bodies 3 are separated from debris resulting from the grinding. If the grinding substance was added in the optional step 11, then, in step 13, the ceramic bodies 3 are also separated from the grinding substance. The separation may be carried out by e.g. flushing the ceramic bodies 3 with water (or another appropriate liquid) and sieving. Alternatively, the separation may be carried out by sedimentation because the ceramic bodies 3 will sag much faster than the small abrasive particles of the grinding substance.

A particular procedure for producing ceramic bodies 3 having chamfered edges 5 according to the invention is described in the following non-limiting example.

For partial wavelength conversion of blue LEDs, YAG:Ce ceramic slabs are usually machined to a predefined thickness and subsequently diced into platelets. 25 ml of such platelets (typial size ˜1×˜1×˜0.12 mm³) are put into a 100 ml high-density polyethylene bottle. 4 ml (tapped powder volume) of SiC abrasive powder (grit-size 350, 500 or 800, corresponding to, respectively, 23, 13 or 6.5 μm average particle size) and a liquid (f.i. water) are added. The amount of liquid is such that the total overall volume is 75 ml. The closed bottle is put on a roller bench to grind, by rolling, for 24 hours at approximately 30 rpm.

In one embodiment, the rotational speed of the bottle may be between 20 and 60 rotations per minute (rpm), preferably between 25 rpm and 35 rpm, and the grinding time may be between 12 and 48 hours. In other embodiments, the rotational speed may be different, dependent on the viscosity of the mixture of the abrasive particles and the liquid in which the particles are suspended. The viscosity of the mixture may vary between 1 milli-pascal-seconds and 2 pascal-seconds.

The process described herein is different from the usual rolling process of ceramic powders with milling balls, since such balls are harder, larger, and have a significantly higher weight than the powder particles (and thus a higher impact on the powder particles). According to an embodiment of the present invention, the abrasive particles are harder and smaller relative to the ceramic bodies. Persons skilled in the art will recognize that, depending on the type of ceramic bodies to be chamfered, a suitable abrasive material may be chosen with the same or larger hardness than that of the ceramic bodies.

Note that the thickness of the Lumiramic™ platelets was not affected during the barrel-grinding time of 24 hours. Thus, the impact of the abrasive powder appears to be only on the edges of the ceramic bodies.

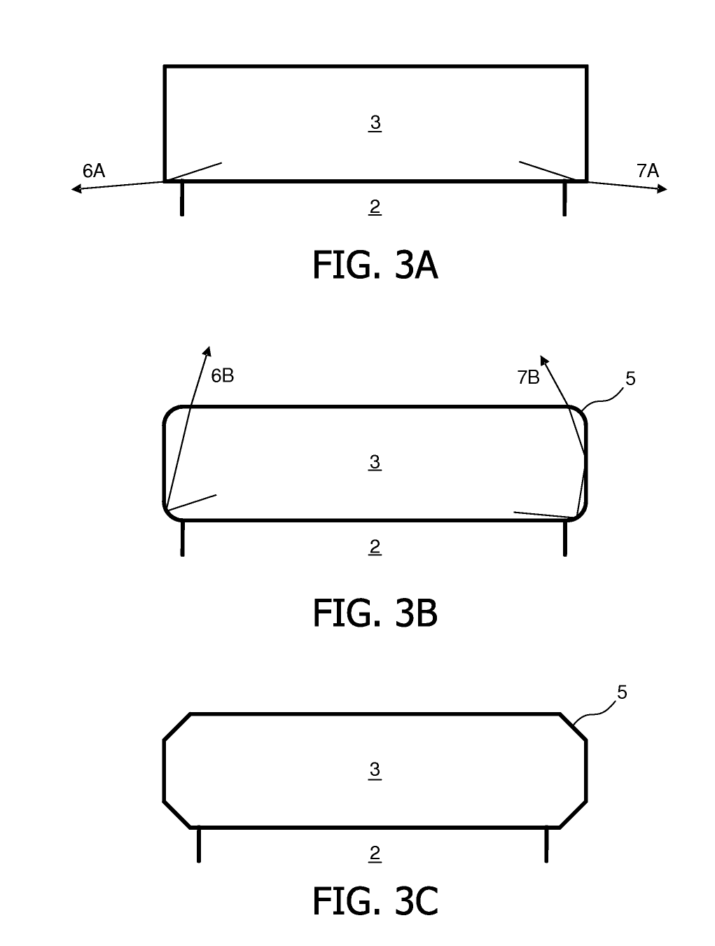

FIG. 3A shows a schematic illustration of a luminescent ceramic body 3 before grinding according to one embodiment of the invention. As shown, before barrel-grinding, the ceramic body 3 may have rectangular or sharp edges resulting from dicing of a ceramic slab into individual ceramic bodies. As previously described, such edges suffer from microscopic chipping and lead to detrimental optical effects. As shown with arrows 6A and 7A, light generated and scattered in the ceramic body 3 under a shallow angle leaves the ceramic body 3 in a direction close to parallel to the upper surface of the light source 2. Thus, this light is not observed by the viewer viewing the mixture of primary and secondary radiation from the top surface of the ceramic body 3.

FIGS. 3B and 3C show schematic illustrations of a luminescent ceramic body after grinding according to different embodiments of the invention. After grinding, the edges 5 of the ceramic body 3 are chamfered. For example, the edges 5 may be rounded off (as shown in FIG. 3B) or faceted (as shown in FIG. 3C). For the rounded edges, the macroscopic radius of curvature may be between 10 micrometers (μm) and 120 μm.

As shown with arrows 6B and 7B, chamfered edges 5 result in a reduction of light leakage and thereby improve the efficiency of the wavelength converting device. In addition, the arrows 6B and 7B also indicate that the chamfered edges 5 enable recycling of the light inside the ceramic body 3. As a result, the fraction of the light leaving the device in essentially the horizontal direction (i.e. parallel to the upper surface of the light source 2) is decreased.

While the forgoing is directed to embodiments of the present invention, other and further embodiments of the invention may be devised without departing from the basic scope thereof. For example, the light source 2 may comprises an LED emitting light of any color (including radiation outside of the visible spectrum), as long as the ceramic body 3 is such that it converts primary radiation emitted by the light source 2 into secondary radiation. Therefore, the scope of the present invention is determined by the claims that follow.

1. A method for post-processing luminescent ceramic bodies comprising the steps of:
adding to a container a predefined amount of luminescent ceramic bodies arranged to convert a primary radiation emitted by a light source into a secondary radiation; and
grinding the luminescent ceramic bodies in the container until edges of the luminescent ceramic bodies are chamfered.

2. The method according to claim 1, further comprising the step of adding to the container a predefined amount of grinding substance.

3. The method according to claim 2, wherein the grinding substance comprises a powder of abrasive particles or abrasive particles suspended in a liquid.

4. The method according to claim 2, further comprising the step of separating the luminescent ceramic bodies from the grinding substance following the grinding step.

5. The method according to claim 4, wherein the step of separating the luminescent ceramic bodies from the grinding substance comprises flushing the luminescent ceramic bodies with a liquid followed by sieving.

6. The method according to claim 4, wherein the step of separating the luminescent ceramic bodies from the grinding substance comprises sedimentation.

7. The method according to claim 1, wherein the step of grinding the luminescent ceramic bodies comprises rolling the luminescent ceramic bodies on a roller bench.

8. The method according to claim 7, wherein rotational speed of the roller bench is between 25 rotations per minute and 35 rotations per minute.

9. The method according to claim 1, wherein the luminescent ceramic bodies are ground in the container for a time period between 12 and 48 hours.

10. The method according to claim 1, wherein the step of grinding the luminescent ceramic bodies in the container until edges of the luminescent ceramic bodies are chamfered comprises grinding the luminescent ceramic bodies in the container until the edges are faceted.

11. The method according to claim 1, wherein the step of grinding the luminescent ceramic bodies in the container until edges of the luminescent ceramic bodies are chamfered comprises grinding the luminescent ceramic bodies in the container until the edges are rounded off.

12. The method according to claim 11, wherein radius of curvature of the rounded off edges is between 10 micrometers and 120 micrometers.

13. A luminescent ceramic body comprising a luminescent ceramic material configured to convert a primary radiation emitted by a light source into a secondary radiation, wherein edges of the luminescent ceramic body are chamfered.

14. The luminescent ceramic body according to claim 13, wherein the edges of the luminescent ceramic body are rounded off with a radius of curvature between 10 micrometers and 120 micrometers.

15. A wavelength converting device comprising:
a light source configured to emit a primary radiation;
a luminescent ceramic body disposed in a path of the primary radiation emitted by the light source and configured to convert the primary radiation into a secondary radiation,
wherein edges of the luminescent ceramic body are chamfered.
